(19) United States
(12) Patent Application Publication
(10) Pub. No.: US 2011/0042974 A1
(43) Pub. Date: Feb. 24, 2011

(54) SAFETY LOCKING MECHANISM FOR DOORS

(75) Inventors: Vianka P. Belyea, Boston, MA (US); Tavinder Phull, Newton, MA (US)

Correspondence Address: WILMERHALE/BOSTON, 60 STATE STREET, BOSTON, MA, 02109, US

(73) Assignee: RHOOST LLC

(21) Appl. No.: 12/544,688

(22) Filed: Aug. 20, 2009

(51) Int. Cl. E05B 9/00

(52) U.S. Cl. 292/348

(57) ABSTRACT

A door locking device has a central body, locking members, and elongated bands with receiving members extending from the central body. The receiving members can be releasably coupled to the locking members, which are shaped to grasp the receiving members, to secure the apparatus to a door.

### BACKGROUND

The present disclosure relates to an apparatus for securing cabinet doors and specifically to a safety lock to limit access by children, the elderly, or pets to cabinets, such as those in kitchens or bathrooms.

### SUMMARY

A locking mechanism has a central body with elongated bands extending away from the central body. The bands can be formed into loops and wrapped around a door handle or knob. The bands have mating portions that allow the bands to be releasably coupled to lock the doors from being opened.

Further, a method of locking two or more doors is disclosed. To lock the door, bands that extend from the central body are rotated around or through projections on or near the doors. A receiving member on the band is releasably coupled to a locking member projecting from the central body or band.

The device has a compact arrangement that can be used to releasably lock doors without having rods extending away from the door. Other features and advantages will become apparent from the following detailed description, drawings, and claims.

### BRIEF DESCRIPTION OF THE DRAWINGS

FIG. 1 is an illustration of the locking apparatus in an unlocked position.

FIG. 2 is an illustration of a top perspective view of the locking apparatus in an unlocked position.

FIG. 3 is a side perspective view of the locking apparatus in a locked position.

FIG. 4 is an illustration of a perspective view of the locking apparatus in an unlocked position.

FIG. 5 is a side perspective view of the locking apparatus in an open position mounted on cabinet doors.

FIG. 6 is a side perspective view of the locking apparatus in a closed position mounted on cabinet doors.

### DETAILED DESCRIPTION

The methods and apparatus described herein relate to the use of an apparatus for securing doors. The device includes bands that wrap around two door projections (knobs) to inhibit access, such as by children.

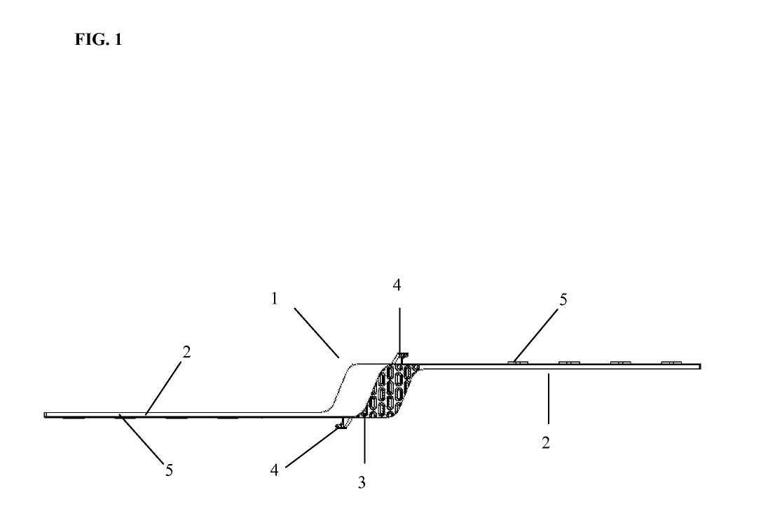

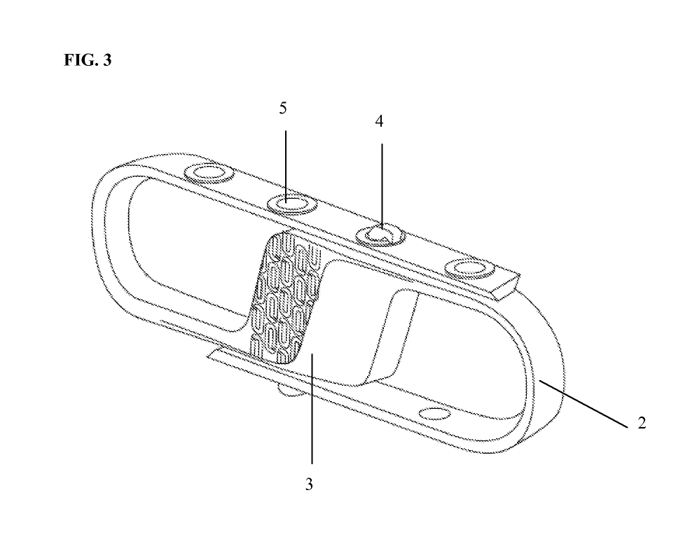

Referring to FIGS. 1-3, a locking system 1 has a central body 3 and bands 2 that extend away from the central body 3 in directions that are opposite to each other. Bands 2 have locking members 4 such as tabs or hooks that can extend from the central body 3 or from the bands 2. Elongated bands 2 also have receiving members 5 such as a series of openings on the band. The receiving members 5 can be releasably coupled to the locking members 4 by forming loops and placing them over the tabs, which are sized and shaped to grasp the receiving members 5. For example, the tabs can have a generally curved or angular shape to allow the bands to be secured and then manually released when desired. The bands 2 and locking members 4 are oriented such that the bands 2 extend laterally and wrap around or through a projection on or near a door and return to the locking members 4 to secure the apparatus 1 in place.

The central body 3 has a generally slanted parallelogram shape with slightly rounded corners, and with a portion having a textured surface. The textured portion is primarily for a distinctive appearance.

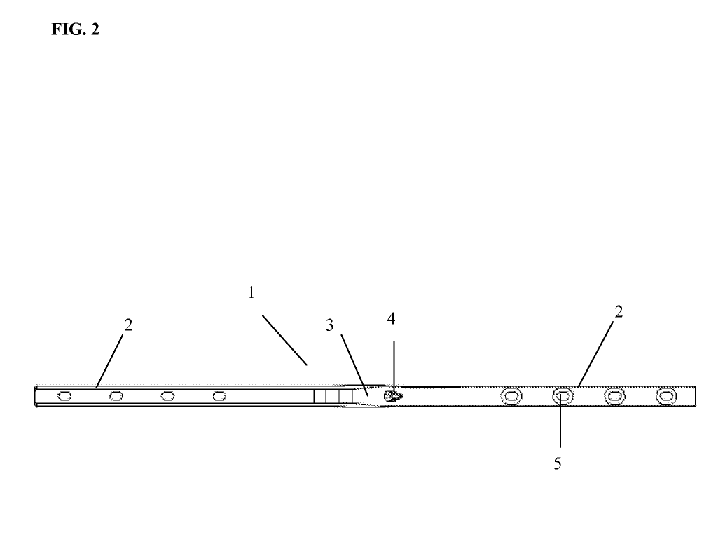

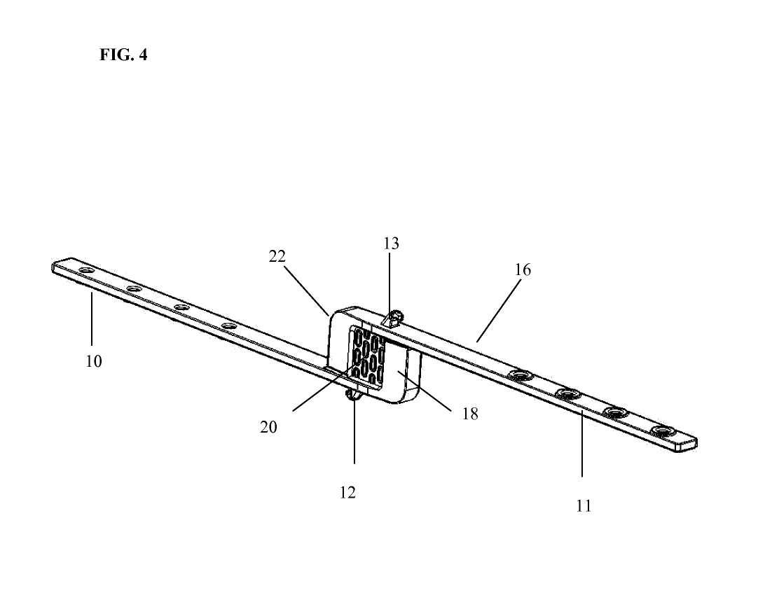

FIGS. 4-6 show another embodiment. While mostly similar to the embodiment of FIGS. 1-3, FIGS. 4-6 show a central body 22 that is generally rectangular with rounded corners. A rectangular peripheral portion 18, which can be made from one or more pieces, surrounds a central rectangular portion 20 that can be recessed and textured. Like the apparatus of FIGS. 1 and 2, apparatus 16 includes two bands, an inferior lateral band 10 and a superior lateral band 11, each extending away from the central body 22 in opposite directions. Further, the apparatus has two locking members, an inferior locking member 12 and superior locking member 13. The locking members 12 and 13 project outwardly and are releasably secured in openings in the bands 10 and 11.

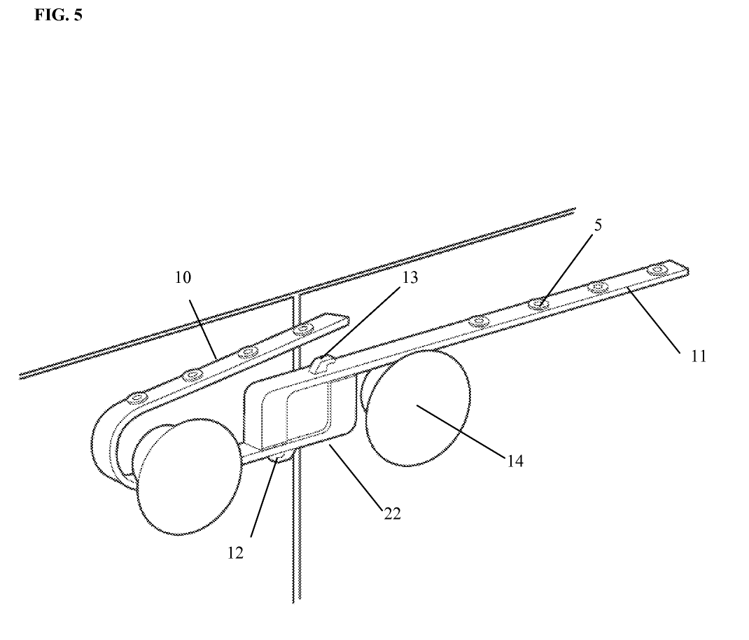

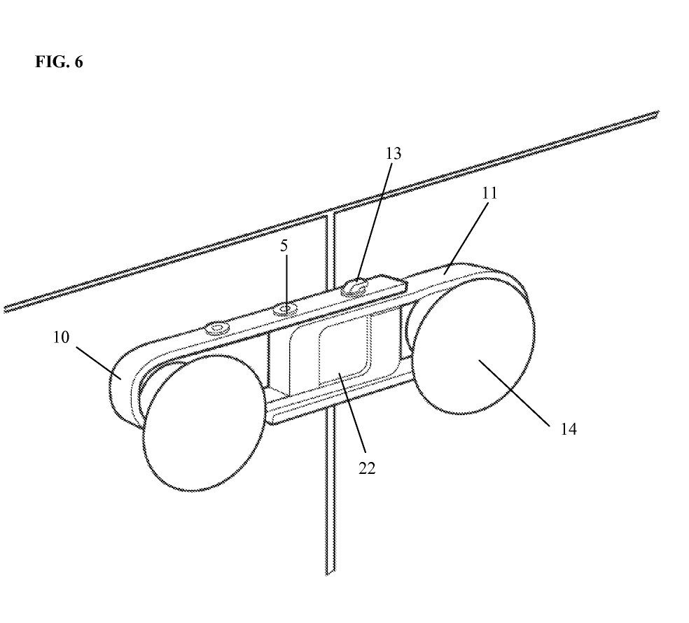

As shown in FIGS. 5 and 6, doors are locked by rotating the superior lateral band 11 around one projection 14 on or near the door, and releasably coupling the inferior locking member 12 to a receiving member 5 on the superior lateral band 11. The opposite side is secured by rotating the inferior lateral band 10 around another door projection 14 and releasably coupling the superior locking member 13 to a receiving member 5 on the inferior lateral band 10. As shown in FIGS. 5 and 6, the locking mechanism is compact around the door knobs, and does not have bands or elongated rods extending away from the knobs.

The doors on which the apparatus 1 and 16 is used can be any type of door from which, or relatively near which, there are at least two projections about which bands can be secured. In one embodiment, the doors are cabinet doors. In another embodiment, they are refrigerator doors.

Further, the apparatus 1 and 16 can be used to secure any number of doors lying along a single plane. To do this, bands are wrapped around the projections 14 from or relatively near the two doors most distal from the center of the apparatus 1 and 16.

There can be a plurality of receiving members 5 on the bands, such as two, three, four, five, or more to allow the size of the loops created by the bands to be made bigger or smaller. This lateral flexibility allows the loops to accommodate different types and sized of handles, which can also be placed at different distances apart in different sets of doors.

While a tab or hook with mating holes are shown, the releasable lock can take one of many different forms, including different forms of tabs and round or elongated openings, indent and detent, a snap fit into an opening, etc. What is generally desirable is for the lock to be generally secure enough to prevent access from children or animals, while allowing the ability to release in a manner that is not very difficult for a typical adult, and capable of being performed manually and without tools.

The bands are made from a substantially flexible but durable material. The bands can be made from an elastomeric material sold under the trademark Santoprene, or a flexible plastic, another elastomer, liquid silicone rubber, or a polymer.

The central body 3 and 13 and locking members 4 are made from rigid and durable materials. In one embodiment, the central body 3 and 22 or locking members 4 are made from Santoprene. In another embodiment, the central body 3 and 22 and/or locking members 4 are made from plastic. In still another embodiment, the central body 3 and 22 and/or locking members 4 are made from metal.

The materials the make up the locking members 4, central body 3 and 22, and the bands can be made from biodegradable and/or recyclable materials.

It is to be understood that while the invention has been described in conjunction with the detailed description thereof, the foregoing description is intended to illustrate and not limit the scope of the inventions, which are defined by the scope of the appended claims. Other aspects, advantages, and modifications are within the scope of the following claims.

What is claimed is:

1. An apparatus for wrapping around two door knobs that are near each other to inhibit the doors from being opened, the mechanism comprising:
a central body,
a first elongated band extending in a first direction away from the central body;
a second elongated band extending in a second direction away from the central body, the first and second directions being substantially opposite to each other;
the first elongated band and the central portion including first locking components, such that the first elongated band can wrap around a first object to create a first loop, and be releasably coupled to the central body with the first locking components;
the second elongated band and the central portion including second locking components, such that the second elongated band can wrap around a second object to create a second loop, and be releasably coupled to the central body with the second locking components;
the first and second bands having a sufficient length to wrap around door knobs to inhibit the doors from being opened;
wherein, when the first and second elongated bands are coupled to the central body around door knobs, the central body is between the door knobs.

2. The apparatus of claim 1, wherein the first and second locking components each include a tab and an opening such that, in each case, the tabs are on one of the central body and each elongated band, and the openings are on the other of the central body and each elongated band.

3. The apparatus of claim 1, wherein the openings are on the bands, and wherein there are a plurality of openings on each band to allow the size of the first and second loops to be varied.

4. The apparatus of claim 1, wherein the lock is made from one of an elastomer, plastic, or metal.

5. The apparatus of claim 1, wherein the bands are made from a substantially flexible material.

6. The apparatus of claim 5, wherein the bands are made from an elastomer or plastic.

7. The apparatus of claim 1, wherein the door is one of a cabinet door or refrigerator door.

8. An apparatus for locking doors that each have a door projection, comprising:
a central body;
two bands, a superior lateral band and an inferior lateral band, extending away from the central body; and
two locking members, an inferior and superior locking member,
the doors being locked by rotating the superior lateral band around one door projection and releasably coupling the inferior locking member to a receiving member on the superior lateral band, and rotating the inferior lateral band around a second door projection and releasably coupling the superior locking member to a receiving member on the inferior lateral band.

9. The apparatus of claim 8, wherein there are a plurality of receiving members on each of the lateral bands.

10. The apparatus of claim 8, wherein the lock is made from one of an elastomer, plastic, or metal.

11. The apparatus of claim 8, wherein the lateral bands are made from a substantially flexible material.

12. The apparatus of claim 8, wherein the door is one of a cabinet door or a refrigerator door.

13. A method comprising using the apparatus of claim 1 to lock two doors.

14. The method of claim 13, wherein the first and second locking components each include a tab and an opening such that, in each case, the tabs are on one of the central body and each elongated band, and the openings are on the other of the central body and each elongated band.

15. The method of claim 13, wherein the openings are on the bands, and wherein there are a plurality of openings on each band to allow the size of the first and second loops to be varied.
